(19) United States
(12) Patent Application Publication
(10) Pub. No.: US 2006/0221983 A1
(43) Pub. Date: Oct. 5, 2006

(54) Communications backbone, a method of providing a communications backbone and a telecommunication network employing the backbone and the method

(75) Inventors: Alexandros Cavgalar, Wichita, KS (US); Robert D. Richmond, Wichita, KS (US); Kenneth R. Stuchlik, Towanda, KS (US)

Correspondence Address: HITT GAINES P.C., P.O. BOX 832570, RICHARDSON, TX, 75083, US

(73) Assignee: Lucent Technologies Inc., Murray Hill, NJ (US)

(21) Appl. No.: 11/093,768

(22) Filed: Mar. 30, 2005

(51) Int. Cl. H04L 12/56; H04B 7/212; H04L 12/28; H04L 12/66

(52) U.S. Cl. 370/401; 370/442; 370/352

(57) ABSTRACT

The present invention provides a communications backbone for connecting first and second telecommunication nodes. In one embodiment, the communications backbone includes a first time division multiplexed gateway associated with the first telecommunication node and configured to be directly connected to a packet-switched network. Additionally, the communications backbone also includes a second time division multiplexed gateway associated with the second telecommunication node and configured to be directly connected to the packet-switched network to form a communications trunk between the first and second telecommunication nodes.

### TECHNICAL FIELD OF THE INVENTION

The present invention is directed, in general, to communication networks and, more specifically, to a communications backbone, a method of providing a communications backbone and a telecommunication network employing the backbone or the method.

### BACKGROUND OF THE INVENTION

The public switched telephone network (PSTN) is a concatenation of the public circuit-switched telephone networks located throughout the world and represents perhaps the largest structure ever created by human activity. Originally, it was a network of fixed-line analog telephone systems. Now, it is almost entirely digital and includes mobile as well as fixed telephone stations. Today's PSTN is based on a large range of technologies extending from analog to digital, accommodates services ranging from modern multimedia to antiquated handsets and provides network transmission capabilities typically employing microwave, optical fiber and copper wire.

In a circuit-switched network, such as the PSTN, a physical connection path is determined and dedicated to a single connection between two end-points in the network, for the duration of the connection. Therefore, resources on that particular path are unavailable to other users of the network for the duration of the connection. Conversely, in a packet-based network, small units of data called packets are routed through the network based on a destination address contained within each packet. This provides a connection path that is non-dedicated (i.e., connectionless), rather than the dedicated connection path employed in the circuit-switched network. This allows the same connection path to be used by a collection of end-points at any given time. Circuit-switched networks can communicate with each other through a packet-switched network as an internetworking solution. However, gateway routers are typically required to accommodate this solution.

A gateway is a node on a network that serves as an entrance to another network. In packet-switched networks, a router is typically a device that determines the next network point to which a packet should be forwarded toward its destination. Therefore, a gateway router is a router that directs packets associated with two networks. Gateway routers are required to add additional IP/UDP packet header information to their transmissions, which is removed later at a receiving end. This required operation results in an additional overhead for the transported data. Additionally, frame structure, byte alignment and synchronous signaling requirements are often present at the gateway end, which also reduce data transfer capabilities. These overhead requirements, coupled with the equipment and maintenance costs associated with gateway routers, tend to offset the benefits associated with their use in internetworking circuit-switched networks and packet-switched networks.

Accordingly, what is needed in the art is an enhanced way to accomplish the functionality associated with gateway routing between circuit-based and packet-based networks.

### SUMMARY OF THE INVENTION

To address the above-discussed deficiencies of the prior art, the present invention provides a communications backbone for connecting first and second telecommunication nodes. In one embodiment, the communications backbone includes a first time division multiplexed gateway associated with the first telecommunication node and configured to be directly connected to a packet-switched network. Additionally, the communications backbone also includes a second time division multiplexed gateway associated with the second telecommunication node and configured to be directly connected to the packet-switched network to form a communications trunk between the first and second telecommunication nodes.

In another aspect, the present invention provides a method of providing a communications backbone for connecting first and second telecommunication nodes. The method includes connecting a first time division multiplexed gateway associated with the first telecommunication node directly to a packet-switched network. The method also includes further connecting a second time division multiplexed gateway associated with the second telecommunication node directly to the packet-switched network to form a communications trunk between the first and second telecommunication nodes.

The present invention also provides, in yet another aspect, a telecommunication network. The telecommunication network includes first and second telecommunication nodes and a communications backbone. The communications backbone has a first time division multiplexed gateway associated with the first telecommunication node that is directly connected to a packet-switched network. The communications backbone also has a second time division multiplexed gateway associated with the second telecommunication node that is directly connected to the packet-switched network to form a communications trunk between the first and second telecommunication nodes.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a diagram of an embodiment of a telecommunication network constructed in accordance with the principles of the present invention;

FIG. 2 illustrates a diagram of an alternative embodiment of a telecommunication network constructed in accordance with the principles of the present invention;

FIG. 3 illustrates a transmission diagram of an embodiment of a communications backbone constructed in accordance with the principles of the present invention; and

FIG. 4 illustrates a flow diagram of an embodiment of a method of providing a communications backbone carried out in accordance with the principles of the present invention.

### DETAILED DESCRIPTION

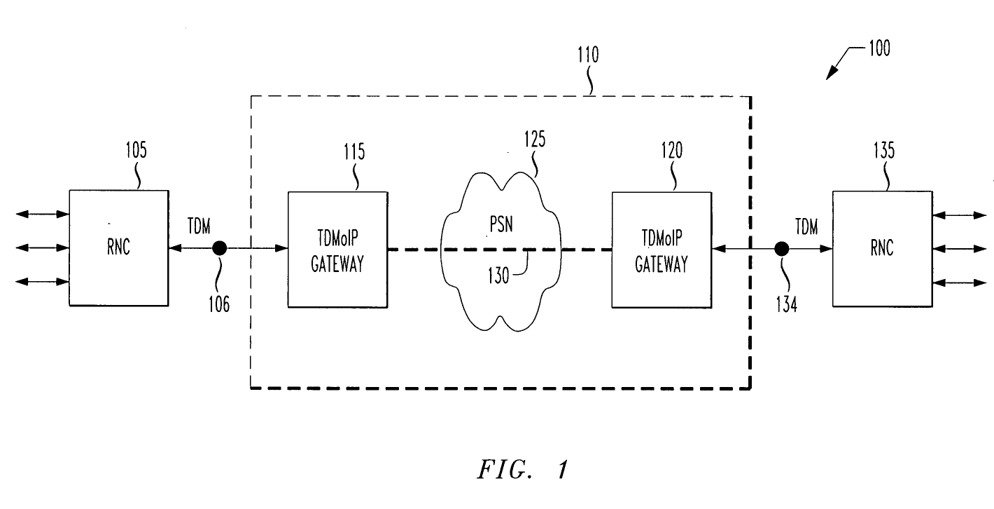

Referring initially to FIG. 1, illustrated is a diagram of an embodiment of a telecommunication network, generally designated 100, constructed in accordance with the principles of the present invention. The telecommunication network 100 includes first and second radio network controllers (RNCs) 105, 135 respectively coupled to first and second telecommunication nodes 106, 134 that employ a communications backbone 110.

The communications backbone 110 includes first and second time division multiplex over Internet protocol (TDMoIP) gateways 115, 120 that couple the first and second telecommunication nodes 106, 134 across a packet-switched network (PSN) 125 employing a packet-based transmission format 130. The first TDMoIP gateway 115 is directly connected to the PSN 125, and correspondingly, the second TDMoIP gateway 120 is also directly connected to the PSN 125 to form a communications trunk between the first and second telecommunications nodes 106, 134.

Generally, each of the first and second RNCs 105, 135 provides hand-off assistance, mobility management and terminal-level security for usually more than one cellular base station. They are typically located in central office environments and can support many radio nodes installed at a cell site, which in turn can support hundreds of subscribers. The communications backbone 110 allows the first and second RNCs 105, 135 to communicate directly with each other as well as with backhaul routers. This may be accomplished without utilizing a traditional packet gateway router to gain access to the PSN 125 and without using traditional T1 links, as normally required.

Architecturally, the communications backbone 110 operates as a traditional TDM infrastructure and avoids the high cost of set-up and maintenance associated with plesiosynchronous digital hierarchy network or a full packet network (e.g., VLAN, MPLS, SONET, IP, UDP). In addition, the communications backbone 110 may be advantageously employed by Internet service providers (ISPs) to enhance or expand existing services without extensive capital investments. A significant benefit of employing the communications backbone 110 is the ability to bring managed PSNs operationally close to unmanaged PSNs or mixed PSNs, such as the Internet. This approach allows ISPs to communicate inside their network easily, again without the use of expensive packet routers.

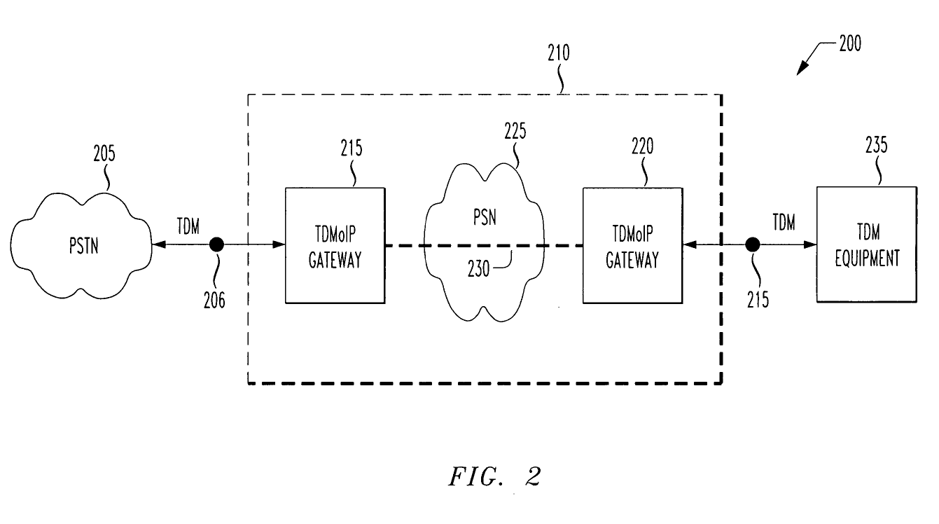

Turning now to FIG. 2, illustrated is a diagram of an alternative embodiment of a telecommunication network, generally designated 200, constructed in accordance with the principles of the present invention. The telecommunication network 200 includes a public switched telephone network (PSTN) 205 coupled to a communications backbone 210 that is further coupled to time division multiplex (TDM) equipment 235. The communications backbone 110 includes first and second TDMoIP gateways 215, 220 that couple first and second telecommunication nodes 206, 215 across a PSN 225 employing a packet-based transmission format 230.

In the illustrated embodiment of FIG. 2, circuit-switched networks such as the PSTN 205 may communicate with each other as well as to the TDM based equipment 235 more efficiently without employing packet gateway routers. Any PSTN that is purely cell centric (i.e., classic digital phone service equipment such as a digital central office switching system 5ESS and ATM aggregation equipment, for example) may be employed with the communications backbone 210. In addition, any T1/E1/J1 aggregation equipment or routers with T1 connections as well as Ethernet equipment may also be employed with the communications backbone 210. The communications backbone 210 may be installed in modular form in an external link portion (i.e., uplink) of the TDM equipment 235 to create an end-to-end communication. This may be accomplished as a single Peripheral Component Interconnect (PCI) mezzanine carrier (PMC) card.

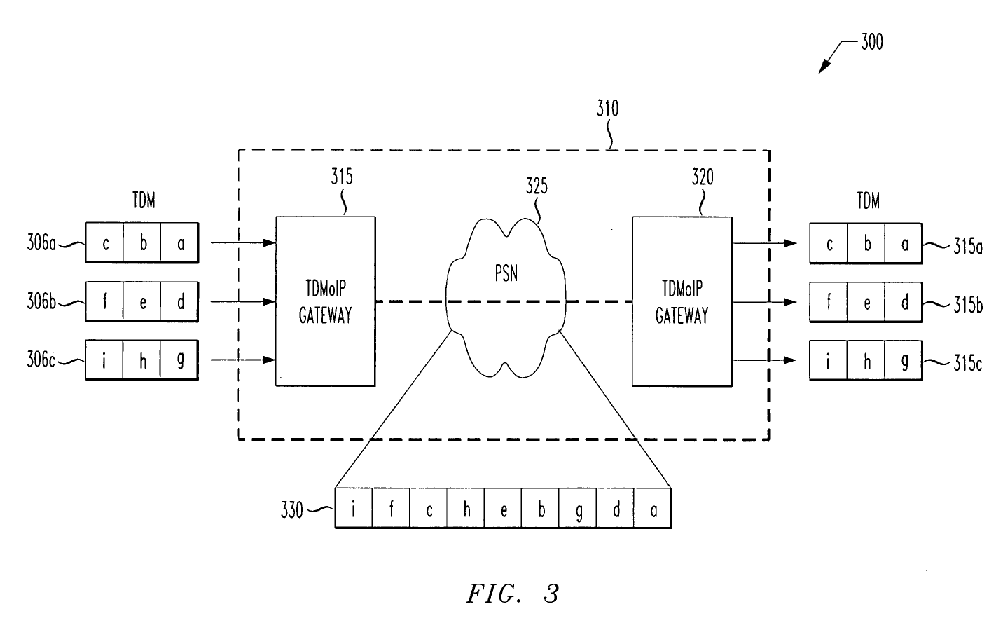

Turning now to FIG. 3, illustrated is a transmission diagram of an embodiment of a communications backbone, generally designated 300, constructed in accordance with the principles of the present invention. The communications backbone 300 includes first and second TDMoIP gateways 315, 320 and a PSN 325. The first TDMoIP gateway 315 accepts first, second and third TDM input signals 306a, 306b, 306c, representing a first telecommunication node, for transmission over the PSN 325 to the second TDMoIP gateway 320, which provides first, second and third TDM output signals 315a, 315b, 315c, representing a second telecommunication node. The TDM output signals 315a, 315b, 315c are seen to be respective reconstructions of the TDM input signals 306a, 306b, 306c. A transmission format 330 represents a transmission of the TDM input signals 306a, 306b, 306c from the first TDMoIP gateway 315 through the PSN 325 to the second TDMoIP gateway 320.

In the illustrated embodiment, the first TDMoIP gateway 315 accepts first, second and third TDM input signals 306a, 306b, 306c, irrespective of protocol or signaling, to provide the substantially transparent transmission format 330. In the illustrated embodiment, the transmission format 330 is based on the International Telecommunications Union (ITU) Y.1413 standard thereby removing a need for frame structure, byte alignment, and additional signaling to create a transparent, streamed-bit transmission. The first TDMoIP gateway 315 receives the input signals 306a, 306b, 306c in a fashion similar to time slot interchangers where a portion of the blocks are transferred one after another until all the payload is transferred. At the receiving end, the blocks are reassembled by the second TDMoIP gateway 320 and transmitted to their destination ports. The packet sizes are flexible depending on an available slot length or time and can be adjusted accordingly.

The PSN 325 may employ any of a variety of packet switching protocols. The output of the first TDMoIP gateway 315 may be directly connected to an Ethernet Switch or a Cisco 2500 series router, for example. The PSN 325 may also be any packet-switched network that has connections similar to Ethernet (e.g., Gigabit Ethernet), optical communication (e.g., OC-3/OC-12 fiber link) or another appropriate media link. Additionally, a communication link may be set within the first and second TDMoIP gateways 315, 320 having known communication information provided.

When the output communication is in another line interface link (i.e., TDM types of traffic), a link layer processing engine within the first TDMoIP gateway 315 maps an input packet to a desired output by utilizing or setting the required OSI layer one indicator. These indicators may be High Level Data Link Control (HDLC) framing or Frame Relay exchangers, for example. Each layer in an OSI stack employs two parts. A first part assures that communication with the adjacent lower layer is accomplished wherein this is called a layer one communication for the MAC layer, which is layer two in the OSI stack.

A second part assures that communication with an adjacent upper layer is accomplished wherein this is called a layer three communication for the MAC layer two. Since the layer one communication deals with the link layer, which is layer one in the OSI stack, the transmission does not require additional link indicators. Therefore, the frame will be transmitted transparently to the second TDMoIP gateway 320. Correspondingly, processing engines within the first and second TDMoIP gateways 315, 320 are able to transparently process traffic streams without additional and unnecessary overhead. In alternative embodiments, additional features may be employed. For example, by adding a Content Accessible Memory (CAM) interface or a hashing engine, the first and second TDMoIP gateways 315, 320 may accommodate full stream data plane processing, which is a core function employed in many routers.

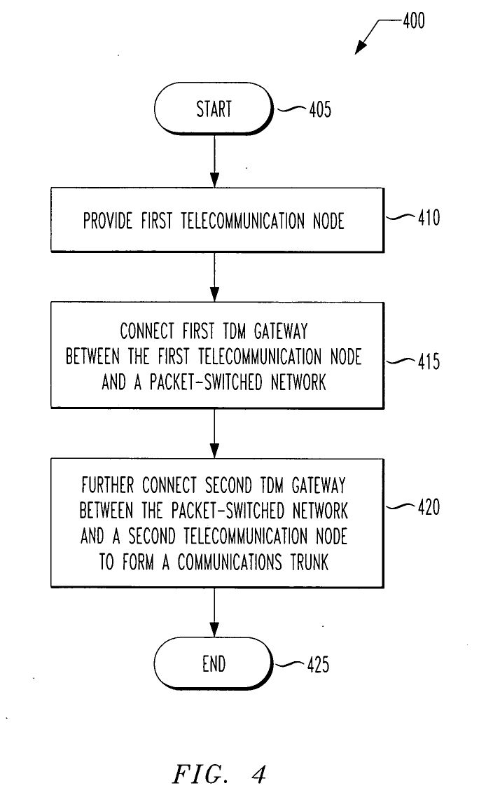

Turning now to FIG. 4, illustrated is a flow diagram of an embodiment of a method of providing a communications backbone, generally designated 400, carried out in accordance with the principles of the present invention. The method 400 starts in a step 405, and a first telecommunication node is provided in a step 410 wherein the first telecommunication node may accommodate a plurality of time division signals. Then in a step 415, a first time division multiplexed gateway is connected between the first telecommunication node and a packet-switched network. In one embodiment, the packet-switched network is a managed packet-switched network, and in an alternative embodiment, the packet-switched network is a mixed packet-switched network.

In a step 420, a second time division multiplexed gateway is connected between the packet-switched network and a second telecommunication node to form a communications trunk. The communication trunk accommodates the plurality of time division signals from the first telecommunication node and provides them to the second telecommunication node. In the illustrated embodiment, the first and second time division multiplexed gateways conform to the ITU-Y.1413 standard. In alternative embodiments, other current or future-developed standards may be employed as appropriate to a particular application. Additionally, a PSTN, a radio network controller or TDM equipment such as 5ESS may employ the first and second telecommunication nodes. The method 400 ends in a step 425.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or grouping of the steps is not a limitation of the present invention.

In summary, embodiments of the present invention employing a communications backbone, a method of providing a communications backbone and a telecommunication network employing the backbone or the method have been presented. Advantages include the ability to provide a transparent, pure streamed bit transmission thereby removing the requirement for frame structure, byte alignment and signaling often employed by other communications backbones. This feature enhances payload throughput and removes the need for packet routers, such as gateway routers, at each end of a packet-switched network.

Although the present invention has been described in detail, those skilled in the art should understand that they can make various changes, substitutions and alterations herein without departing from the spirit and scope of the invention in its broadest form.

What is claimed is:

1. A communications backbone for connecting first and second telecommunication nodes, comprising:
a first time division multiplexed gateway associated with said first telecommunication node and configured to be directly connected to a packet-switched network; and
a second time division multiplexed gateway associated with said second telecommunication node and also configured to be directly connected to said packet-switched network to form a communications trunk between said first and second telecommunication nodes.

2. The backbone as recited in claim 1 wherein said first and second telecommunication nodes accommodate a plurality of time division signals.

3. The backbone as recited in claim 1 wherein at least one of said first and second telecommunication nodes is coupled to a public switched telephone network (PSTN).

4. The backbone as recited in claim 1 wherein at least one of said first and second telecommunication nodes is coupled to a central office switch.

5. The backbone as recited in claim 1 wherein at least one of said first and second telecommunication nodes is coupled to a radio network controller.

6. The backbone as recited in claim 1 wherein said packet-switched network is selected from the group consisting of:
a managed packet-switched network; and
a mixed packet-switched network.

7. The backbone as recited in claim 1 wherein said first and second time division multiplexed gateways conform to the International Telecommunications Union (ITU) Y.1413 standard.

8. A method of providing a communications backbone for use with first and second telecommunication nodes, comprising:
connecting a first time division multiplexed gateway associated with said first telecommunication node directly to a packet-switched network; and
further connecting a second time division multiplexed gateway associated with said second telecommunication node directly to said packet-switched network to form a communications trunk between said first and second telecommunication nodes.

9. The method as recited in claim 8 wherein said first and second telecommunication nodes accommodate a plurality of time division signals.

10. The method as recited in claim 8 wherein at least one of said first and second telecommunication nodes is coupled to a public switched telephone network (PSTN).

11. The method as recited in claim 8 wherein at least one of said first and second telecommunication nodes is coupled to a central office switch.

12. The method as recited in claim 8 wherein at least one of said first and second telecommunication nodes is coupled to a radio network controller.

13. The method as recited in claim 8 wherein said packet-switched network is selected from the group consisting of:
a managed packet-switched network; and
a mixed packet-switched network.

14. The method as recited in claim 8 wherein said first and second time division multiplexed gateways conform to the International Telecommunications Union (ITU) Y.1413 standard.

15. A telecommunication network, comprising:
first and second telecommunication nodes; and
a communications backbone, including:
a first time division multiplexed gateway associated with said first telecommunication node that is directly connected to a packet-switched network; and
a second time division multiplexed gateway associated with said second telecommunication node that is also directly connected to said packet-switched network to form a communications trunk between said first and second telecommunication nodes.

16. The network as recited in claim 15 wherein said first and second telecommunication nodes accommodate a plurality of time division signals.

17. The network as recited in claim 15 wherein at least one of said first and second telecommunication nodes is coupled to a public switched telephone network (PSTN).

18. The network as recited in claim 15 wherein at least one of said first and second telecommunication nodes is coupled to a central office switch.

19. The network as recited in claim 15 wherein at least one of said first and second telecommunication nodes is coupled to a radio network controller.

20. The network as recited in claim 15 wherein said packet-switched network is selected from the group consisting of:
a managed packet-switched network; and
a mixed packet-switched network.

21. The network as recited in claim 15 wherein said first and second time division multiplexed gateways conform to the International Telecommunications Union (ITU) Y.1413 standard.
